(19) United States
(12) Patent Application Publication
(10) Pub. No.: US 2021/0206442 A1
(43) Pub. Date: Jul. 8, 2021

(54) AUXILIARY WHEEL UNIT SUPPORTED BY SINGLE STAND AND BICYCLE

(71) Applicant: CROPS CO., LTD., KOBE (JP)

(72) Inventor: KEIJI TAIGA, KOBE (JP)

(21) Appl. No.: 16/733,544

(22) Filed: Jan. 3, 2020

(51) Int. Cl. B62H 1/12

(52) U.S. Cl. CPC B62H 1/12

(57) ABSTRACT

An auxiliary wheel unit of a bicycle contains a connection portion mounted on a body of the bicycle on a side of a rear wheel of a bicycle, and is rotatably supported by the connection portion on one end side in a longitudinal direction. A movably leg swings between a standing position and an upturn position, a locking piece is rotatably supported by the movable leg and is engaged with the connection portion at the standing position of the movable leg, the connection portion. A spring is connected to the movable leg so as to abut against the connection portion and the locking piece in opposite directions so that the swinging direction of the movable leg changes between the standing position and the upturn position of the movable leg. In addition, an auxiliary wheel is attached to the other end of the bicycle.

### FIELD OF THE INVENTION

The present invention relates to an auxiliary wheel unit supported by a single stand and a bicycle.

### BACKGROUND OF THE INVENTION

An auxiliary wheel of a bicycle is connected to on a side of a rear wheel of the bicycle. Conventionally, the auxiliary wheel is connected to an end of an arm and the bicycle by securing the other end of the arm to the side of a shaft of the rear wheel with a bolt. The auxiliary wheel is used based on using requirements.

As described above, the auxiliary wheel is connected to the shaft of the rear wheel through the arm. When desiring to stop the auxiliary wheel, it is necessary to remove the auxiliary wheel from the bicycle for each arm. Because it is not easy for connection and detachment of the auxiliary wheel, stopping the auxiliary wheel is quite difficult. In addition, it is time-consuming to operate the auxiliary wheel. It is difficult for connection and detachment of the auxiliary wheel, and it is important to simplify the installation of the auxiliary wheel. In addition, there is a high possibility that a falling accident or the like may occur during riding the bicycle.

When using the arm to rotate between the standing posture and the upturn posture with respect to the bracket portion connected to the body of the bicycle, it is possible to assist without removing the bracket portion from the body. Using or non-using of a wheel can be selected as disclosed in Japanese Patent Publication No. 2003-19987.

As disclosed in Japanese Publication No. 2003-19987, the arm of the auxiliary wheel structure is moved to the standing posture position, and the locking piece is engaged with the bracket portion to fix the arm in the standing posture. However, the user who uses the auxiliary wheel is often young and may forget to securely engage the locking piece with the bracket portion. Accordingly, the arm may unintentionally move to the upturn posture while riding the bicycle.

The present invention has arisen to mitigate and/or obviate the afore-described disadvantages.

### SUMMARY OF THE INVENTION

The primary aspect of the present invention is to provide an auxiliary wheel unit supported by a single stand and a bicycle which are capable of enhancing the usability of the auxiliary wheel so as to stop a falling accident.

To obtain above-mentioned aspect, an auxiliary wheel unit supported by a single stand according to a preferred embodiment of the present invention is configured to be connected to a body of a bicycle on a side of a rear wheel of the bicycle. The auxiliary wheel unit is rotatably supported by a connection portion connected to the body of the bicycle and is located on a side of the connection portion in a longitudinal direction between an upright position and an upturn position. A movable leg portion is rotatably supported and swingable between a standing position and an upturn position, a locking piece is rotatably supported by the movably leg and engaged with the connection portion at the standing position of the movable leg. A spring member is connected to the connection portion and the locking piece and biases the connection portion and the locking piece in the opposite direction so that the swing direction of the movable leg changes between the standing position and the upturn position of the movable leg. And an auxiliary wheel is attached to the other end of the movable leg.

The movable leg of the auxiliary wheel unit swings between the upright position and the upturn position, the auxiliary wheel is operated by swinging the movable leg. A spring abuts against the connection portion and the locking piece in opposite directions so that a swing direction of the movable leg changes between the standing position and the upturn position of the movable leg. The locking piece is engaged with the connection portion by moving the movable leg to the upright position. Therefore, the auxiliary wheel unit enhances the usability of the auxiliary wheels while preventing a falling accident.

The locking piece is disposed outside the movable leg, the outer support plate is connected to the spring, and the inner support plate is disposed inside the movable leg. A rotary shaft that is connected to the movable leg and is erected on a side edge of the outer support plate outside the connection portion and the spring with respect to the rotary shaft. And a pushing portion is used for unlocking. Thus, the user pushes the pushing portion by hand so that the movable leg is moved to the upturn position easily and safely.

The movable leg is connected to the rotary shaft, a first portion, a second portion extending from the first portion laterally. Preferably, an upper end of the auxiliary wheel is located above a lower end of the pushing portion in a standing position of the movable leg. Thereby, the movable leg is connected to the first portion to which the rotary shaft is connected, and the second portion extends from the first portion. The third portion is attached to the auxiliary wheel, wherein the upper end of the auxiliary wheel is located above the lower end of the pushing portion in the upright position of the movable leg, thus avoiding the user's foot contacting the locking piece to avoid the falling accident.

A side edge of the outer support plate on the rising direction side is disposed between the straight portion and the connection portion to which the pushing portion is connected. And an inclined portion is inclined to the pushing portion in the upright direction, such that it is easy to release the locked state by pushing the pushing portion. Thus, it is easy to avoid the user's foot unintentionally contacting with the locking piece.

Preferably, the inclination angle of the straight portion with respect to the central axis of the movable leg is more than the inclination angle of the connection portion with respect to the central axis of the movable leg in a side view at the standing position of the movable leg. Thereby, when the inclination angle of the straight portion with respect to the central axis of the movable leg is more than the inclination angle of the connection portion with respect to the center axis of the leg portion in a side view at the standing position of the leg portion, the pushing portion is operated. It is possible to prevent the locking piece from being unintentionally pushed by the user's foot, thus avoiding releasing the locked state accidentally.

A bicycle according to another embodiment of the present invention is made to solve the above-described problems of the e auxiliary wheel unit.

Since the bicycle includes the auxiliary wheel unit, the auxiliary wheel is configured to avoid the falling accident.

### BRIEF DESCRIPTION OF THE DRAWINGS

FIG. 1 is a schematic side view showing an upright position of an auxiliary wheel unit supported by a single stand and connected to a bicycle according to a preferred embodiment of the present invention.

FIG. 2 is a schematic side view showing an upturn position of the auxiliary wheel unit of FIG. 1 connected to the bicycle.

FIG. 3 is a front plan view showing an upright position state of the auxiliary wheel unit of FIG. 1.

FIG. 4 is a cross sectional view taken alone the line A-A of FIG. 1.

FIG. 5 is a side plan view showing an engagement state of a locking piece and a connection portion of the auxiliary wheel unit of FIG. 4.

FIG. 6 is a side plan view showing the releasing state of the auxiliary wheel unit of FIG. 1.

### DETAILED DESCRIPTION OF THE PREFERRED EMBODIMENTS

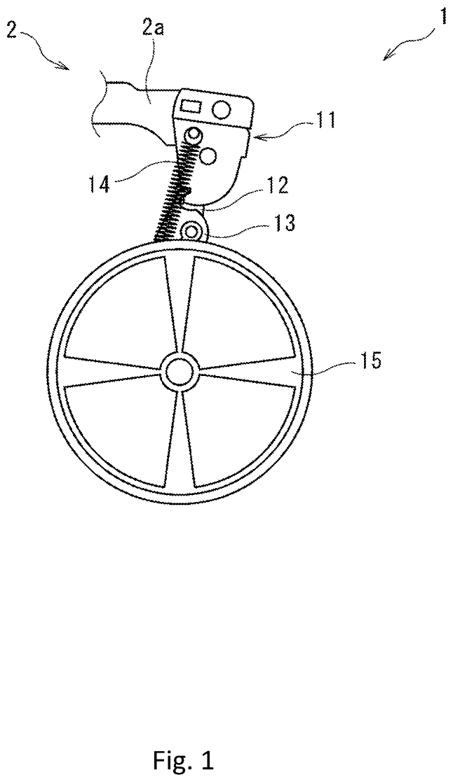

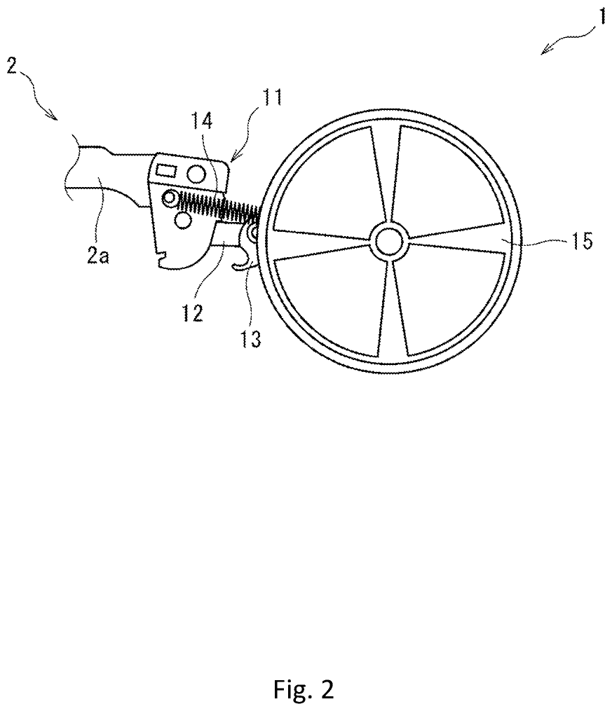

With reference to FIGS. 1 to 3, an auxiliary wheel unit 1 supported by a single stand according to a preferred embodiment of the present invention is configured to be connected to a body 2a of a bicycle 2 on a side of a rear wheel. The auxiliary wheel unit 1 is rotatably supported by a connection portion 11 connected to the body 2a of the bicycle 2 and is located on a side of the connection portion 11 in a longitudinal direction between an upright position and an upturn position of FIG. 1. A locking piece 13 is rotatably supported by a movable leg 12 and is engaged with the connection portion 11 at an upright position of the movable leg 12 which is connected to the connection portion 11 and the locking piece 13, a spring 14 pushes the connection portion 11 and the locking piece 13 in an opposite direction so that a swinging direction of the movable leg 12 changes between the upright position and the upturn position. An auxiliary wheel 15 is shown in FIGS. 1 to 3, and the auxiliary wheel unit 1 is connected to the body 2a on a left side of the bicycle 2, the auxiliary wheel unit 1 is located on a right side of the bicycle 2, for example, the auxiliary wheel unit 1 is connected to the body 2a. Referring to FIGS. 1-3, when the auxiliary wheel unit 1 is connected to the body 2a on the right side of the bicycle 2, the auxiliary wheel unit 1 operates on the basis of a virtual plane which divides the bicycle 2 in the left and right direction.

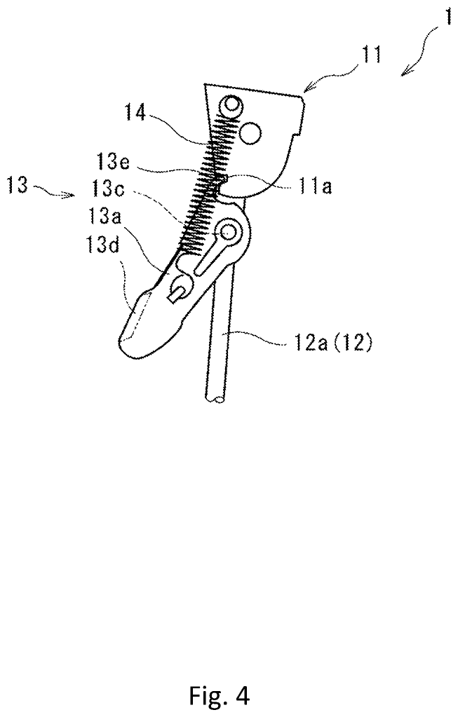

The connection portion 11 is fixed to, for example, a frame of the bicycle 2 near a shaft of the rear wheel of the bicycle 2. As shown in FIG. 4, the connection portion 11 has a fixing hole 11e engaged with an engagement portion 13e of the locking piece 13 at the upright position of the movable leg 12.

An outer support plate 13a is elongated, a rotary shaft 13c is connected to a side in a longitudinal direction, and a pushing portion 13d is provided on the other side in the longitudinal direction. Specifically, the outer support plate 13a has a rectangular shape in a side view and has a pair of side edges extending in the longitudinal direction. The pushing portion 13d is connected to an end portion of the outer support plate 13a at the other side opposite to the rotary shaft 13c of an edge in a rising direction.

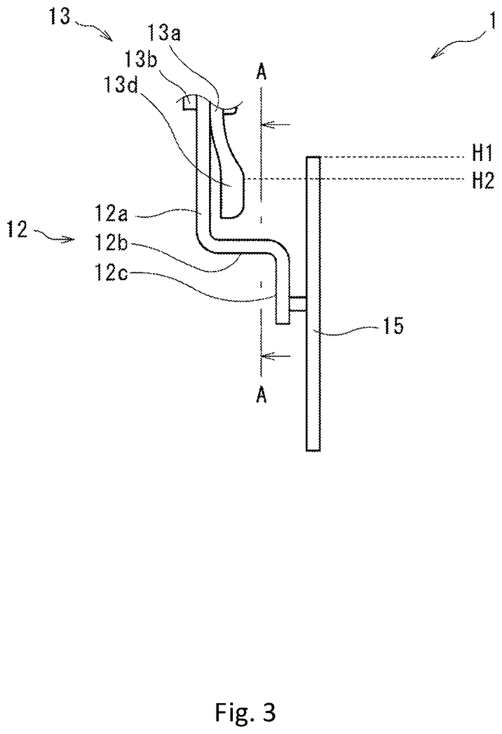

As shown in FIGS. 3 and 4, the locking piece 13 is disposed outside the movable leg 12, and the outer support plate 13a is connected to the spring 14 and the inside of the movable leg 12. The rotary shaft 13c is fixed between the outer support plate 13a and an inner support plate 13b and is connected to the movable leg 12, wherein the spring 14 is fitted beside the rotary shaft 13c. And the pushing portion 13d is erected on the side edge of the outer support plate 13a on the upright direction side (front in the upright position). The locking piece 13 connects the side edges of the outer support plate 13a and the inner support plate 13b in the upright direction, and is engaged with the locking hole 11a of the connection portion 11 at the upright position of the movable leg 12. An engagement portion 13e has a base portion extending between side edges of the outer support plate 13a and the inner support plate 13b, and a hook of the engagement portion 13e projects from the base portion to the connection portion 11. The hook is inserted into the locking hole 11a after moving. In other words, in the auxiliary wheel unit 1, the locking piece 13 also swings in the upright direction around the rotary shaft 13c in a state where the swinging direction of the movable leg 12 changes from the upturn direction to the upright direction. It is configured to be inserted into the locking hole 11a. After the pushing portion 13d is pushed into the auxiliary wheel unit 1, the base contacts with the movable leg 12. In the auxiliary wheel unit 1, the swing direction of the movable leg 12 and the locking piece 13 changes in the upturn direction by further pushing the pushing portion 13d in the upturn direction, and the movable leg 12 is moved to the upturn position. Therefore, the auxiliary wheel unit 1 can easily and safely move the movable leg portion 12 to the upturn position by pushing the pushing portion 13d manually. In addition, the outer support plate 13a, the inner support plate 13b, the pushing portion 13d, and the engagement portion 13e are integrally formed. In addition, the boundary between the components may be curved. The outer support plate 13a has an elongated shape, the rotary shaft 13c is attached to one side of the locking piece 13 longitudinally, and the pushing portion 13d is provided at the other end of the locking piece 13 longitudinally. Specifically, the outer support plate 13a has a substantially rectangular shape in side view, and has a pair of side edges extending longitudinally. The pushing portion 13d is connected to an end of the outer support plate 13a opposite to the rotary shaft 13c.

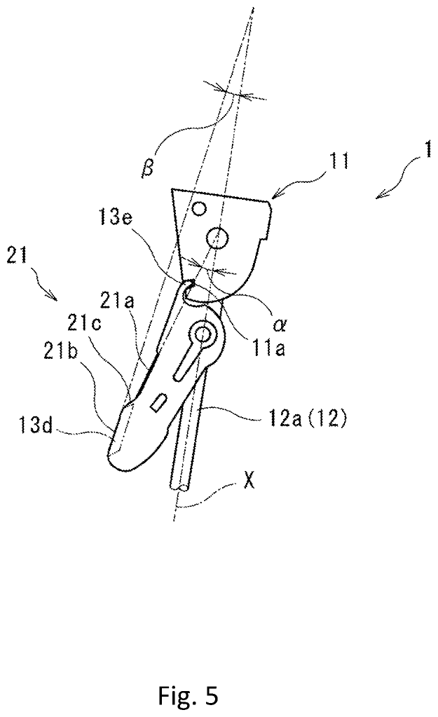

As shown in FIG. 5, the side edge 21 of the outer support plate 13a is disposed between the straight portion 21a and the coupling portion 21b to which the pushing portion 13d is connected. And an inclined portion 21c is inclined to the pushing portion 13d in the upright direction. The straight portion 21a, the inclined portion 21c, and the coupling portion 21b are provided in order from one side of the side edge 21 (to which the rotary shaft 13c is attached) to the other side of the side edge. The auxiliary wheel unit 1 is provided with the inclined portion 21c between the straight portion 21a and the coupling portion 21b, so that the central axis X of the movable leg portion 12 can be viewed from the side at a standing position of the movable leg 12. The inclination angle α of the straight portion 21a with respect to the central axis of the straight portion 12a) is reduced. Accordingly, the swing width of the locking piece 13 with respect to the straight portion 21a is reduced, and it is easy to prevent a removal of the engagement portion 13e from the locking hole 11a due to unintended contact with the straight portion 21a. Further, in the auxiliary wheel unit 1, by providing the inclined portion 21c between the straight portion 21a and the coupling portion 21b, the coupling portion 21b is protruded in the upright direction, and the user manually presses the pushing portion 13d easily. Therefore, the auxiliary wheel unit 1 facilitates unlocking by pushing the pushing portion 13d so as to prevent an accidental removal, when the user's foot unintentionally contacts with the straight portion 21a.

The straight portion 21a is arranged in the side edge 21 of the outer support plate 13a in the upright direction proximate to a coupling portion 21b with the engagement portion 13e. The straight portion 21a is provided, for example, continuously with the coupling portion 21b.

The coupling portion 21b is provided at an end of the side edge 21 of the outer support plate 13a in the upright direction opposite to the engagement portion 13e. The coupling portion 21b is linear. In addition, the coupling portion 21b is in a trapezoidal shape or a circular arc shape, wherein a central portion of the coupling portion 21b protrudes in the rising direction with respect to both end portions.

The inclined portion 21c is provided continuously with the straight portion 21a and the coupling portion 21b, or is provided between one or both of the straight portion 21a and the coupling portion 21b via another portion.

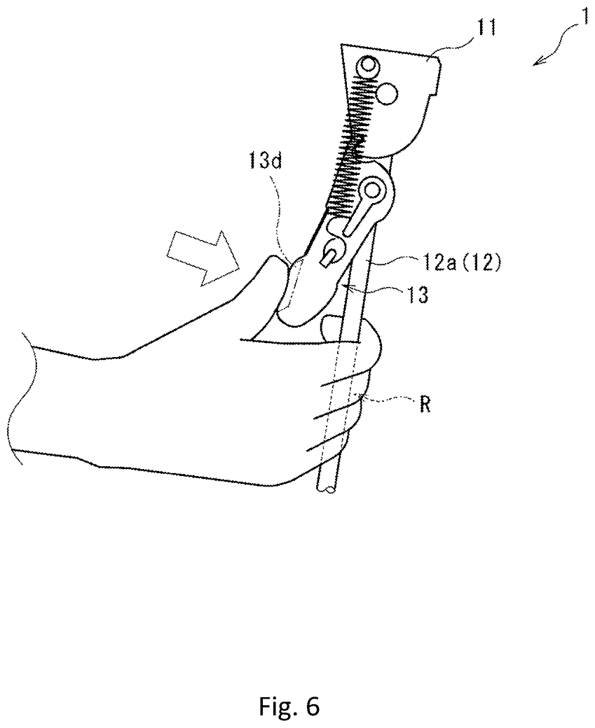

As shown in FIG. 5, in a side view at the standing position of the movable leg 12, the inclination angle α of the straight portion 21a with respect to the central axis X of the movable leg 12 is less than the inclination angle β of the coupling portion 21b with respect to the central axis X of the movable leg 12. By reducing the inclination angle β, it is possible to suppress the pushing portion 13d from being unintentionally pushed by the user's foot, and it is possible to further reduce the possibility that the locked state is a released accidentally. According to this configuration, as shown in FIG. 6, the user pushes the pushing portion 13d easily with his/her thumb, while holding the movable leg 12 with a finger other than the thumb. Therefore, it is possible to easily release the locked state by pushing the pushing portion 13d, and it is easy to reduce the possibility that the locked state is released by mistake. The “inclination angle of the coupling portion with respect to the central axis of the movable leg” is the average value of the inclination angle with respect to the central axis of the movable leg, when the coupling portion is equally divided along the side edge. The “central axis of the movable leg” refers to the central axis of the straight portion to which the locking piece is connected.

The length of the straight portion 21a is more than the length of the inclined portion 21c. The minimum ratio of the length of the straight portion 21a to the length of the inclined portion 21c is 2 or is 3. The auxiliary wheel unit 1 suppresses unintended contact with the inclined portion 21 by increasing the ratio of the length of the straight portion 21a to the length of the inclined portion 21c, and prevents the locked state from being accidentally released. On the other hand, the maximum ratio is 8 or is 6. If above-mentioned ratio exceeds the maximum ratio, the locking piece 13 is unnecessarily large.

The pressing piece 13d protrudes laterally from the coupling portion 21b. The pushing portion 13d protrudes outward in the left-right direction or protrudes inward. For example, when the pushing portion 13d protrudes inward in the left-right direction, it is easy to push the pushing portion 13d with the user's finger, and it is easy to suppress the user's feet from unintentionally contacting with the pushing portion 13d.

The movable leg 12 is, for example, rod-shaped. As shown in FIGS. 3 and 4, the respective one movable leg 12 is laterally continuous with the first portion 12a to which the rotary shaft 13c is connected (attached to the bicycle 2). A second portion 12b extends outwardly, and a third portion 12c extending from the second portion 12b to which the auxiliary wheel 15. The movable leg 12 has the first portion 12a, the second portion 12b, and the third portion 12c in order from one end to the other end of the movable leg 12. The movable leg 12 is rotatably supported by the connection portion 11 at one end of the first portion 12a, and the auxiliary wheel 15 is attached to the other end of the third portion 12c.

The first portion 12a is connected to the locking piece 13 by the rotary shaft 13c. As shown in FIG. 6, the first portion 12a is positioned between the other end of the locking piece 13 (on which the pushing portion 13d is formed) and the second portion 12b is gripped by the user at the standing position of the moving leg 12, wherein the second portion 12b has a gripping region R that is be gripped by the user. As shown in FIG. 3, in the upright position of the movable leg 12, it is preferable that the upper end of the auxiliary wheel 15 is located above the lower end of the pushing portion 13d. The auxiliary wheel unit 1 prevents the user's foot from unintentionally contacting with the locking piece 13 by the auxiliary wheel 15, because the upper end of the auxiliary wheel 15 is positioned higher than the lower end of the pushing portion 13d.

As shown in FIG. 3, at the upright position of the movable leg 12, the height position H1 of the upper end of the auxiliary wheel 15 is preferably equal to or higher than the height position H2 of the upper end of the locking piece 13d. It is more preferable that the height position H1 of the upper end is higher than the height position H2 of the upper end of the pushing portion 13d. Thus, it possible to prevent the user's feet from unintentionally contacting with the locking pieces 13.

The spring 14 urges the connection portion 11 and the locking piece 13. The spring 14 swings the locking piece 13 in the upright direction at the upright position of the movable leg 12. The spring 14 swings the movable leg 12 and the locking piece 13 in the upturn direction as the pushing portion 13d is pushed inward. The biasing force of the spring 14 is relatively small so that the pushing portion 13d is easily pushed by the user's hand.

The bicycle 2 includes the auxiliary wheel unit which is only on one side of the rear wheel or on each of both sides of the rear wheel.

Since the auxiliary wheel unit 1 is configured to swing between the standing position and the upturn position, the auxiliary wheel 15 is operated by swinging the movable leg 12. The auxiliary wheel unit 1 faces the connection portion 11 and the locking piece 13, such that the spring 14 changes the swinging direction of the movable leg 12 between the standing position and the upturn position of the movable leg 12. The locking piece 13 is engaged with the connection portion 11 by moving the movable leg 12 to the upright position. Therefore, the auxiliary wheel unit 1 enhances the usability of the auxiliary wheel 15 while prevent a falling accident.

The bicycle 2 includes the auxiliary wheel unit 1, so the usability of the auxiliary wheel 15 is improved while preventing the falling accident.

The locking piece is configured to be unlocked by being pushed by the user's finger, but the specific configuration of the locking piece is not limited to the configuration of the above-described embodiment. It is not necessary to have a pushing portion. When the locking piece has the outer support plate, the side edge of the outer support plate on the upright direction side does not have the above-described straight portion, the coupling portion, and the inclined portion. When the outer support plate has the straight portion, the connecting portion, and the inclined portion, the inclination angle of the straight portion with respect to the central axis of the movable leg in a side view at the standing position of the movable leg is determined. It is also possible to fix the inclination angle of the inclined portion with respect to the central axis to be equal to or less than the inclination angle.

The movable leg does not necessarily have the first, second and third portions. In addition, the auxiliary wheel unit may adopt a configuration in which the upper end of the auxiliary wheel is located lower than the lower end of the pushing portion at the standing position of the movable leg.

As described above, the auxiliary wheel unit according to the present invention improves the usability of the auxiliary wheels, while preventing a falling accident and being applicable for the bicycle.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An auxiliary wheel unit comprising:
a connection portion attached to a body of a bicycle on a side of a rear wheel of a bicycle;
a movable leg rotatably supported by the connection portion at one end in a longitudinal direction and swinging between a standing position and an upturn position;
a locking piece rotatably supported by the movable leg, and engaged with the connection portion at an upright position of the movable leg, connected to a locking piece, and the upturn position and the upturn position of the movable leg;
a spring configured to abut against the connection portion and the locking piece in opposite directions so as to change a swinging direction of the movable leg between the standing position and the upturn position of the movable leg;

2. The auxiliary wheel unit as claimed in claim 1, wherein an outer support plate is disposed to the locking piece outside the movable leg, and the outer support plate is connected to the spring; an inner support plate is disposed inside the movable leg; and a rotating shaft is connected to the movable leg.

3. The auxiliary wheel unit as claimed in claim 2, wherein the respective one movable leg is laterally continuous with a first portion to which the rotary shaft is connected, and a second portion extends from the first portion laterally, and a third portion extends from the second portion, wherein an upper end of the auxiliary wheel is located above a lower end of a pushing portion in the standing position of the movable leg.

4. The auxiliary wheel unit as claimed in claim 2, wherein a side edge of the outer support plate on a rising direction side is disposed between a straight portion, the pushing portion is connected to the straight portion and the connecting portion, and an inclined portion is inclined to the pushing portion in an upright position of the movable leg.

5. The auxiliary wheel unit as claimed in claim 3, wherein a side edge of the outer support plate on a rising direction side is disposed between a straight portion, the pushing portion is connected to the straight portion and the connecting portion, and an inclined portion is inclined to the pushing portion in an upright position of the movable leg.

6. The auxiliary wheel unit as claimed in claim 4, wherein an inclination angle of the straight portion with respect to a central axis of the movable leg is more than an inclination angle of the connection portion with respect to the central axis of the movable leg.
